(19) United States
(12) Patent Application Publication
(10) Pub. No.: US 2010/0138139 A1
(43) Pub. Date: Jun. 3, 2010

(54) METHOD FOR ADJUSTING THERMAL COMFORT IN A VEHICLE UPON STOPPING AND STARTING THE ENGINE

(75) Inventors: Joan Gibert, Chatenay Malabry (FR); Vincent Braunschweig, Fontenay Aux Roses (FR); Herve Couetoux, Les Molieres (FR); Florent Coffin, Ecardenville Sur Eure (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT SAS, Boulogne-Billancourt (FR)

(21) Appl. No.: 12/527,282

(22) PCT Filed: Jan. 30, 2008
(86) PCT No.: PCT/FR2008/050144

§ 371 Date: Jan. 27, 2010

(30) Foreign Application Priority Data
Feb. 16, 2007 (FR) 0753294

(51) Int. Cl. F02D 43/00; B60H 1/00

(52) U.S. Cl. 701/112; 701/113; 165/202

(57) ABSTRACT

A method for adjusting thermal comfort in a vehicle upon stopping and starting the engine. The method defines main conditions essentially relating to water temperature of the engine, to temperature inside the vehicle, to windshield fogging risk, and to risk of odors in the evaporator of the air-conditioning loop. The engine off period is limited on the basis of these conditions. This limitation can be implemented by a prohibition to stop the engine or by restarting the engine.

### TECHNICAL FIELD

In a conventional vehicle, the engine remains in operation throughout the duration of the journey, whether the vehicle is running or whether it is stopped, for example at a red light. The thermal comfort service is therefore provided by known means such as hot and cold loops.

In a vehicle equipped with the engine stop and start function, the engine is switched off when the speed is zero or also zero. Most of the services of the vehicle are switched off or degraded. However, it is important, even essential, to continue to offer some of these services, for example defogging of the windshield.

One solution for maintaining the thermal comfort while the engine of the vehicle is stopped is to fit additional air conditioning/heating systems, ranging from a simple kilogram calorie storage evaporator to more complex solutions such as an electrical compressor powered by batteries. However, these solutions are costly.

The subject of the present invention is a method for adjusting thermal comfort for a vehicle upon stopping and starting (sometimes called Stop&Start) the engine that does not require the addition of extra air conditioning/heating equipment.

These aims are achieved in accordance with the invention by the fact that main conditions are defined that relate in particular to the engine water temperature, to the temperature inside the passenger compartment of the vehicle, to the risk of fogging of the windshield, to the risk of odors in the evaporator of the air conditioning circuit, and that the engine off time is limited on the basis of these conditions.

Advantageously, on the one hand, the engine off time is limited by restarting the engine and, on the other hand, the occurrence of the stops (duration and number) is reduced by a prohibition on stopping the engine while running. These two actions are generated in the supervisory logic controller of the stop and start function.

According to a first condition relating to the engine cooling water temperature, used preferably in cold weather, the switching off of the engine is prohibited as long as the engine cooling water temperature measurement is less than a threshold value S1 (S1 between 50° C. and 60° C.)

The air conditioning computer has access to the engine water temperature measurement and the condition is applied each time the engine is switched off to determine the off time. If the condition is not fulfilled during the off time, the engine restarts.

According to a second condition relating to the temperature inside the passenger compartment, the temperature inside the passenger compartment is measured and the engine is restarted immediately the difference between this temperature and a target temperature departs from a predetermined interval.

The temperature difference in the passenger compartment between the target temperature and the measured temperature is maintained within the interval [−a; +a] with a being between 1° C. and 5° C. This value will depend on the fuel/antipollution comfort/cost effectiveness trade-off. A tried and tested reasonable order of magnitude is between 1° C. and 5° C.

This condition is fundamental in that it determines the thermal comfort inside the passenger compartment. The trade-off between thermal comfort service and stopping and starting the engine depends on the tolerance range that is allowed for the comfort error parameter. If this range is great, a major comfort degradation is conceded, otherwise fewer or shorter engine switch-offs are accepted.

Advantageously, the interval [−a; +a] varies dynamically according to the outside conditions. For example, on starting the vehicle, the interval is widened to allow the engine to be stopped. This interval is tightened in stabilized conditions to match the comfort of the passengers as closely as possible.

According to a third condition relating to the risk of fogging of the windshield, if the vehicle has a relative humidity sensor, the degree of relative humidity of the air in the passenger compartment of the motor vehicle is measured using the relative humidity sensor and the engine is restarted when the relative humidity sensor detects a risk of fogging of the windshield.

If the vehicle has no relative humidity sensor, the driver provokes the restarting of the engine of the vehicle by pressing the fast defogging control button when a fogging of the windshield is observed. A second activation, within a predetermined time if there is a persistent risk of fogging, prohibits the switching off of the engine for a determined duration. In one embodiment, the user has a last resort to restart by pressing on a button disabling the stop/start mode.

Finally, according to a fourth condition relating to the risk of bad odors, by measuring the temperature of the evaporator of the air conditioning circuit using a probe or even by computing this temperature in the air conditioning computer, the engine is restarted when the temperature of the evaporator exceeds a threshold value.

This condition can be put in place with no outside temperature condition or else, it can be put in place on the basis of a certain outside temperature. In this case, the engine is restarted when the outside temperature exceeds a threshold value and the fourth condition is fulfilled.

These strategies can be complemented with a specific management of the acoustics of the air conditioning/heating pulser. In practice, if the engine is switched off, the noise of the pulser is no longer covered by that of the engine and an acoustic discomfort may develop. In this case, the speed of rotation of the air conditioning/heating pulser is reduced when the engine is switched off. The acoustic discomfort due to the ventilation is thus reduced, but the blown air speed over the passengers is also reduced, which is offset by the fact that the blown air temperature rise is slowed down. In other words, the speed of the air is reduced but the blown air is colder.

The blown air speed over the passengers is reduced, which is, when the outside temperature is between 20° C. and 40° C. (hot season), offset by the slowing down of the blown air temperature rise, and symmetrically, when the outside temperature is between −10° C. and 20° C. (in the cold season), this is offset by the slowing down of the lowering of the blown air temperatures. In other words, the air speed is reduced but the blown air remains cold for longer (condition between 20° C. and 40° C.) or hot for longer (condition between −10° C. and 20° C.)

In the case where the vehicle is equipped with an additional electric water pump on the cooling circuit (which may be the case independently of the stop and start function: for example, extreme cold comfort or cooling of turbo bearings), it is advantageously restarted when the engine is stopped in order to maintain a water flow rate in the air cooler and thus maintain the heating service for longer on stopping the engine. The first condition can be enriched by continuing to measure the engine water temperature during the stop: the engine is restarted if this water temperature ends up becoming less than the threshold S1 (this duration is far greater than the duration of a usual stop).

These different conditions are fully applicable to a vehicle equipped with automatic air conditioning which, using many sensors and computers, provides a way of knowing the thermal comfort and visibility conditions inside the vehicle and therefore better managing the trade-off between stopping and starting the engine and thermal comfort.

If the vehicle is equipped with manual air conditioning, the trade-off between the two services depends more on the driver. The latter can give priority to one of the two services at will. A button disabling the stopping and starting of the engine enables him to give priority to thermal comfort over stopping and starting the engine. If, when the engine is stopped, the driver wants to restart the engine, a press on this control enables him to restart the vehicle.

The first and fourth conditions remain valid. The absence of a computer and of associated sensors is offset by simpler laws relying solely on the outside temperature and by the timers managing the stop time and the time between two stops. The occurrence of stops is restricted all the more as the outside temperature increases, in particular from 25° C. The maximum duration of a stop (ts) is reduced from approximately a minute when the ambient temperature is greater than 25° C. to become zero for an ambient temperature of 35° C. for example. The minimum stop prohibition duration (ti) that must elapse when running before re-authorizing a stop increases with the outside temperature (example: ti varies from 0 second at 25° C. to 1 minute at 35° C.; these are indicative values).

For example at the start of a journey, the occurrence of stops is limited to enable the comfort of the passenger vehicle to be achieved more rapidly. During this acclimatization phase, failing the availability of real information concerning the passenger compartment conditions, as in regulated air conditioning, the control algorithm acts preventively. For example, at the start of running, the outside temperature can be artificially offset to lie deliberately within an engine stop restriction zone.

Other features of the invention will become further apparent from the appended figures. In these figures:

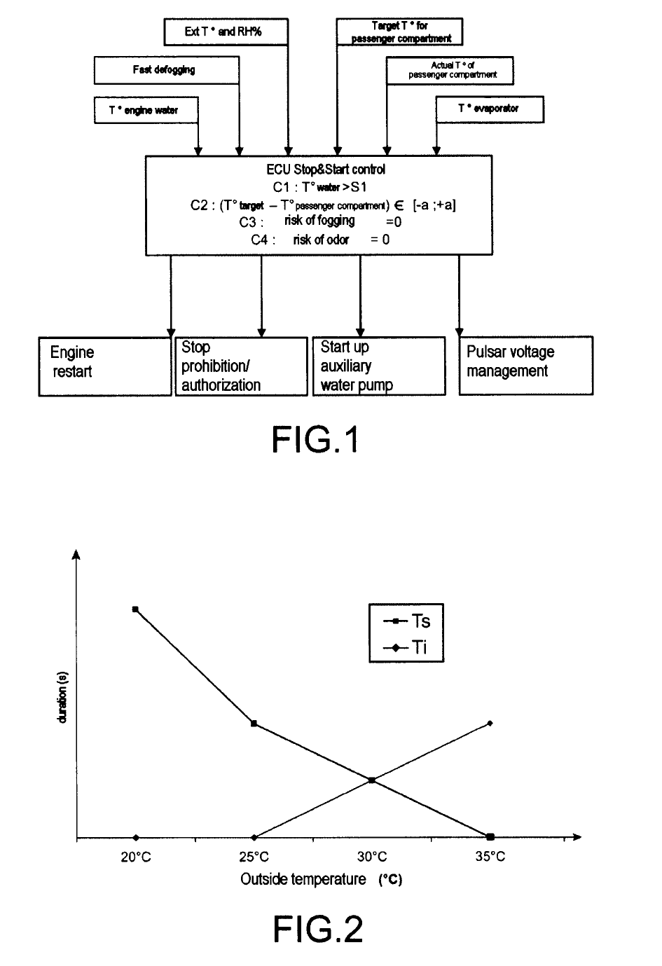

FIG. 1 is a diagram of the process of the inventive method;

FIG. 2 is a graph of the stop times and of times between two stops allowed in manual air conditioning mode.

In FIG. 2, Ti represents the minimum duration between two authorized stops and Tₛ the maximum duration authorized for a stop. As can be seen, the maximum authorized duration of a stop decreases roughly linearly to be canceled out for a temperature of 35° C., whereas the minimum duration between two stops is constant between 20° C. and 25° C. then increases linearly beyond 25° C.

1-12. (canceled)

13. A method for adjusting thermal comfort for a vehicle upon stopping and starting an engine, comprising:
defining conditions that relate to engine water temperature, to temperature inside a passenger compartment of the vehicle, to risk of fogging of a windshield, to risk of odors in an evaporator of an air conditioning circuit; and
limiting engine off time on the basis of the conditions.

14. The method as claimed in claim 13, wherein the engine off time is limited by restarting the engine and occurrence of stops is reduced by a prohibition on stopping the engine while running.

15. The method as claimed in claim 13, wherein the engine water temperature is measured and the engine is restarted immediately when this temperature becomes less than a threshold value.

16. The method as claimed in claim 13, wherein the temperature in the passenger compartment is measured and the engine is restarted immediately when the difference between this temperature and a target temperature departs from a predetermined interval.

17. The method as claimed in claim 16, wherein the temperature difference in the passenger compartment of the vehicle between the target temperature and the measured temperature is maintained within the interval [−a; +a] with a being between 1° C. and 5° C.

18. The method as claimed in claim 17, wherein the interval [−a; +a] varies dynamically according to outside conditions, the interval being widened on starting the vehicle and tightened in stabilized conditions.

19. The method as claimed in claim 13, wherein a degree of relative humidity of the air in the passenger compartment of the vehicle is measured using a relative humidity sensor and the engine is restarted when the relative humidity sensor detects a risk of fogging of the windshield.

20. The method as claimed in claim 13, wherein the restarting of the engine of the motor vehicle is provoked by pressing a rapid defogging control button when a fogging of the windshield is observed.

21. The method as claimed in claim 13, wherein the temperature of the evaporator of the air conditioning circuit is measured using a measuring probe or this temperature is computed in the air conditioning computer and the engine is restarted when the temperature of the evaporator exceeds a threshold value.

22. The method as claimed in claim 21, wherein the engine is restarted when the outside temperature exceeds a threshold value.

23. The method as claimed in claim 13, wherein a speed of rotation of the air conditioning/heating pulser is reduced when the engine is switched off.

24. The method as claimed in claim 13, wherein, in a case the vehicle is equipped with an electric water pump on the cooling circuit, the electric water pump is started up when the engine is stopped to maintain a water flow rate in the unit heater and thus maintain heating service for longer on stopping the engine.
